(19) United States
(12) Patent Application Publication
(10) Pub. No.: US 2014/0192266 A1
(43) Pub. Date: Jul. 10, 2014

(54) METHOD AND APPARATUS OF REDUCING COMPRESSION NOISE IN DIGITAL VIDEO STREAMS

(71) Applicant: Qualcomm Incorporated, San Diego, CA (US)

(72) Inventors: Mainak Biswas, Karnataka (IN); Vasudev Bhaskaran, San Diego, CA (US); Sujith Srinivasan, Karnataka (IN)

(73) Assignee: Qualcomm Incorporated, San Diego, CA (US)

(21) Appl. No.: 13/734,667

(22) Filed: Jan. 4, 2013

(51) Int. Cl. H04N 5/21

(52) U.S. Cl. CPC H04N 5/21
USPC 348/607

(57) ABSTRACT

Method and apparatus for reducing random noise in digital video streams are described. In one innovative aspect, a device for reducing noise of a video stream is provided. The device includes a ringing noise detector configured to identify ringing noise in an image included in the video stream. The device further includes a block detector configured to identify a block pattern in the image included in the video stream, the block detector configured to identify block patterns of a predetermined size and block patterns of an arbitrary size. The device also includes a noise reducer configured to filter the image based on the identified ringing noise and the block pattern.

### BACKGROUND

1. Field

The present invention relates to reduction of noise in digital video streams, more specifically to reducing compression noise in digital video streams.

2. Background

Digital video content that is generated, transmitted, and viewed may be affected by noise. Two types of noise are random noise and compression noise. Random noise (which may also be referred to as video noise or Gaussian noise) may be produced by the sensor (e.g., camera) or by transmission of the video over analog channels. Compression noise may arise when digital video is compressed as part of storage or transmission.

Digital video may be compressed to conserve the bandwidth requirements for transmitting and/or storing the video. Uncompressed video may be transmitted if bandwidth from the source to the display is abundantly available. However, this may take more time and resources to transmit than a compressed video. For example, in some implementations, the digital video may be transmitted wirelessly. High-definition video may be captured at a resolution of 1920×1080 at a rate of up to 60 frames per second. The quality of this video continues to improve with the advent of extra high definition video featuring a resolution of 7680×4320 at a rate of 120 frames per second. A user may not be willing to wait for a complete download of the uncompressed high-definition video. Accordingly, the video stream may be compressed.

Compression may introduce noise. For example, compression noise may include so called “mosquito noise” or “ringing noise” which generally refers to stray pixels located near high contrast boundary portions of an image. Because these stray pixels may appear in a first portion and disappear in a subsequent portion, the visual effect of this noise is similar to that of a mosquito buzzing about. Another form of compression noise includes the so called “block noise” which generally refers to a checkerboard pattern that may be seen in a video stream which may correspond to the block size used for compressing the video.

Both random and compression noise may be distracting to the viewer and affect the experience of watching video content—especially on larger displays. Furthermore, the scale and speed at which the images are needed to provide video quality presentation involves processing many pixels in a short period of time. For example, modern televisions may feature 1920×1080 pixels (e.g., over 2 million pixels). As cameras and display technologies gain sophistication and consumers demand higher fidelity, the number of pixels may also increase.

Therefore, there is a need to provide methods and apparatus for reducing compression noise that may be included in digital video streams.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include a noise reducer which does not assume any prior knowledge about the specific compression codec used for the video stream except that the codec is block based. A further non-limiting advantage of the systems and methods described is the ability to detect a variety of block based compression schemes. For example, many compression codecs are based on an 8×8 block. However, as will be described in further detail below, the block size may be dynamically determined such that noise reduction may be performed on video streams compressed using arbitrary block sizes. This provides flexibility for the noise reducer such that it may be used to noise reduce many forms of video. Furthermore, this is useful when processing content that may have been scaled before noise reduction. An additional non-limiting advantage of the systems and methods described is that block noise can be reduced for specific portions of the video data, such as filtering pixels close to the edge of a block rather than applying a filter for deblocking to all pixels of the block. Yet another non-limiting advantage of the systems and methods described includes dynamic noise filtering (e.g., deblocking and/or deringing) based on an overall image quality (e.g., noise) such that good quality content is not filtered at the same level as noisy content.

In one innovative aspect, a device for reducing noise of a video stream is provided. The device includes a ringing noise detector configured to identify ringing noise in an image included in the video stream. The device further includes a block detector configured to identify a block pattern in the image included in the video stream, the block detector configured to identify block patterns of a predetermined size and block patterns of an arbitrary size. The device also includes a noise reducer configured to filter the image based on the identified ringing noise and the block pattern.

In a further innovative aspect, a method for reducing noise of a video stream is provided. The method includes identifying ringing noise in a first image included in the video stream. The method further includes identifying a block pattern in the image included in the video stream, wherein identifying the block pattern includes identifying block patterns of a predetermined size and block patterns of an arbitrary size. The method also includes generating a second image based on the first image, the identified ringing noise, and the block pattern.

Another device for reducing noise of a video stream is also provided. The device includes a processor. The processor is configured to identify ringing noise in a first image included in the video stream. The processor is further configured to identify a block pattern in the image included in the video stream, wherein identifying the block pattern includes identifying block patterns of a predetermined size and block patterns of an arbitrary size. The processor is also configured to generate a second image based on the first image, the identified ringing noise, and the block pattern.

A computer-readable storage medium comprising instructions executable by a processor of an apparatus for noise reduction in a video stream is provided in yet another innovative aspect. The instructions cause the apparatus to identify ringing noise in a first image included in the video stream. The instructions cause the apparatus to identify a block pattern in the image included in the video stream, wherein identifying the block pattern includes identifying block patterns of a predetermined size and block patterns of an arbitrary size. The instructions further cause the apparatus to generate a second image based on the first image, the identified ringing noise, and the block pattern.

Another device for reducing noise of a video stream is also provided. The device includes means for identifying ringing noise in a first image included in the video stream. The device includes means for identifying a block pattern in the image included in the video stream, wherein identifying the block pattern includes identifying block patterns of a predetermined size and block patterns of an arbitrary size. The device also includes means for generating a second image based on the first image, the identified ringing noise, and the block pattern.

These and other implementations consistent with the invention are further described below with reference to the following figures.

### BRIEF DESCRIPTION OF THE DRAWINGS

FIG. 1 illustrates a functional block diagram of an exemplary video encoding and decoding system.

FIG. 2 illustrates a functional block diagram of an exemplary compression noise reducer.

FIG. 3 illustrates a functional block diagram of a deringing filter.

FIG. 4 illustrates a pixel diagram of an exemplary segmentation window.

FIG. 5 is a plot of pixel values illustrating a blocking artifact.

FIG. 6 is a process flow diagram illustrating vertical block grid detection.

FIG. 7 shows a process flow diagram for generalized block grid detection.

FIG. 8 illustrates another plot of pixel values illustrating a blocking artifact.

FIG. 9 illustrates a process flow diagram for a method of reducing noise of a video stream.

FIG. 10 illustrates a functional block diagram for another exemplary noise reducer.

In the figures, to the extent possible, elements having the same or similar functions have the same designations.

### DETAILED DESCRIPTION

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Various aspects of embodiments within the scope of the appended claims are described below. It should be apparent that the aspects described herein may be embodied in a wide variety of forms and that any specific structure and/or function described herein is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

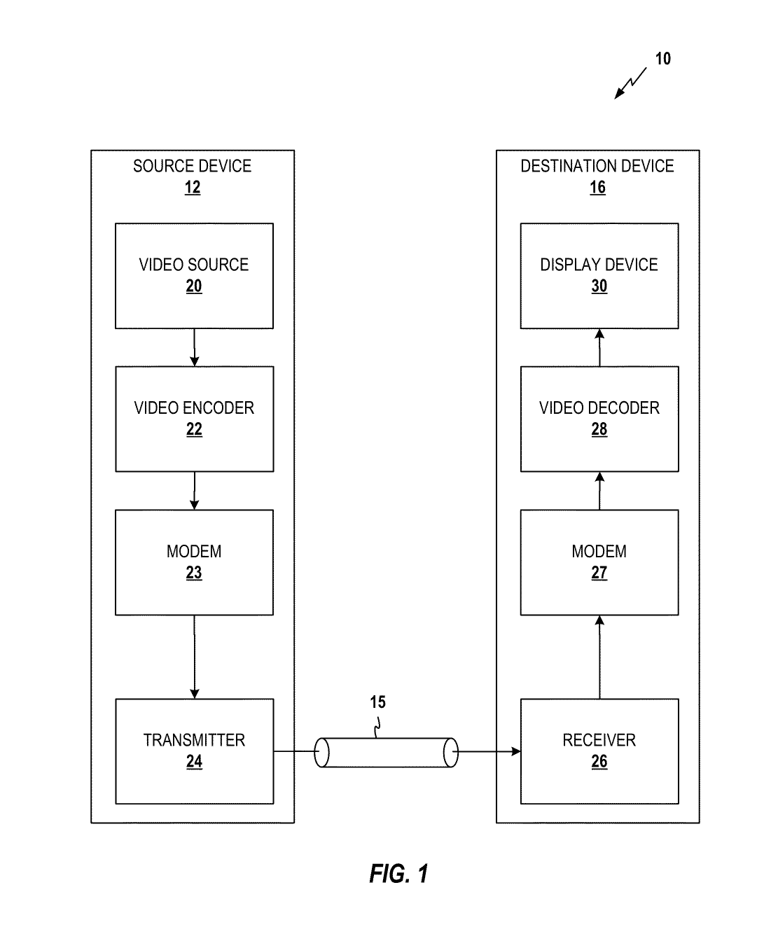

FIG. 1 illustrates a functional block diagram of an exemplary video encoding and decoding system. As shown in FIG. 1, system 10 includes a source device 12 that may be configured to transmit encoded video to a destination device 16 via a communication channel 15. Source device 12 and destination device 16 may comprise any of a wide range of devices, including mobile devices or generally fixed devices. In some cases, source device 12 and destination device 16 comprise wireless communication devices, such as wireless handsets, so-called cellular or satellite radiotelephones, personal digital assistants (PDAs), mobile media players, or any devices that can communicate video information over a communication channel 15, which may or may not be wireless. However, the techniques of this disclosure, which concern the detection and correction of compression noise, may be used in many different systems and settings. FIG. 1 is merely one example of such a system.

In the example of FIG. 1, source device 12 may include a video source 20, video encoder 22, a modulator/demodulator (modem) 23 and a transmitter 24. Destination device 16 may include a receiver 26, a modem 27, a video decoder 28, and a display device 30. In accordance with this disclosure, video encoder 22 of source device 12 may be configured to encode a sequence of frames of a reference image. The video encoder 22 may be configured to encode additional information associated with the images such as 3D conversion information including a set of parameters that can be applied to each of the video frames of the reference sequence to generate 3D video data. Modem 23 and transmitter 24 may modulate and transmit wireless signals to destination device 16. In this way, source device 12 communicates the encoded reference sequence along with any additional associated information to destination device 16.

Receiver 26 and modem 27 receive and demodulate wireless signals received from source device 12. Accordingly, video decoder 28 may receive the sequence of frames of the reference image. The video decoder 28 may also receive the additional information which can be used for decoding the reference sequence.

Source device 12 and destination device 16 are merely examples of such coding devices in which source device 12 generates coded video data for transmission to destination device 16. In some cases, devices 12, 16 may operate in a substantially symmetrical manner such that, each of devices 12, 16 includes video encoding and decoding components. Hence, system 10 may support one-way or two-way video transmission between video devices 12, 16, e.g., for video streaming, video playback, video broadcasting, or video telephony.

Video source 20 of source device 12 may include a video capture device, such as a video camera, a video archive containing previously captured video, or a video feed from a video content provider. As a further alternative, video source 20 may generate computer graphics-based data as the source video, or a combination of live video, archived video, and computer-generated video. In some cases, if video source 20 is a video camera, source device 12 and destination device 16 may form so-called camera phones or video phones. In each case, the captured, pre-captured or computer-generated video may be encoded by video encoder 22. As part of the encoding process, the video encoder 22 may be configured to implement one or more of the methods described herein, such as compression noise detection and/or correction. The encoded video information may then be modulated by modem 23 according to a communication standard, e.g., such as code division multiple access (CDMA) or another communication standard, and transmitted to destination device 16 via transmitter 24. Modem 23 may include various mixers, filters, amplifiers or other components designed for signal modulation. Transmitter 24 may include circuits designed for transmitting data, including amplifiers, filters, and one or more antennas.

Receiver 26 of destination device 16 may be configured to receive information over channel 15. Modem 27 may be configured to demodulate the information. Again, the video encoding process may implement one or more of the techniques described herein such as compression noise detection and/or correction. The information communicated over channel 15 may include information defined by video encoder 22, which may be used by video decoder 28 consistent with this disclosure. Display device 30 displays the decoded video data to a user, and may comprise any of a variety of display devices such as a cathode ray tube, a liquid crystal display (LCD), a plasma display, an organic light emitting diode (OLED) display, or another type of display device.

In the example of FIG. 1, communication channel 15 may comprise any wireless or wired communication medium, such as a radio frequency (RF) spectrum or one or more physical transmission lines, or any combination of wireless and wired media. Accordingly, modem 23 and transmitter 24 may support many possible wireless protocols, wired protocols or wired and wireless protocols. Communication channel 15 may form part of a packet-based network, such as a local area network (LAN), a wide-area network (WAN), or a global network, such as the Internet, comprising an interconnection of one or more networks. Communication channel 15 generally represents any suitable communication medium, or collection of different communication media, for transmitting video data from source device 12 to destination device 16. Communication channel 15 may include routers, switches, base stations, or any other equipment that may be useful to facilitate communication from source device 12 to destination device 16. The techniques of this disclosure do not necessarily require communication of encoded data from one device to another, and may apply to encoding scenarios without the reciprocal decoding. Also, aspects of this disclosure may apply to decoding scenarios without the reciprocal encoding.

Video encoder 22 and video decoder 28 may operate consistent with a video compression standard, such as the ITU-T H.264 standard, alternatively described as MPEG-4, Part 10, and Advanced Video Coding (AVC). The techniques of this disclosure, however, are not limited to any particular coding standard or extensions thereof. Although not shown in FIG. 1, in some aspects, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to a multiplexer protocol (e.g., ITU H.223) or other protocols such as the user datagram protocol (UDP).

Video encoder 22 and video decoder 28 each may be implemented as one or more microprocessors, digital signal processors (DSPs), application specific integrated circuits (ASICs), field programmable gate arrays (FPGAs), discrete logic circuitry, software executing on a microprocessor or other platform, hardware, firmware or any combinations thereof. Each of video encoder 22 and video decoder 28 may be included in one or more encoders or decoders, either of which may be integrated as part of a combined encoder/decoder (CODEC) in a respective mobile device, subscriber device, broadcast device, server, or the like.

A video sequence typically includes a series of video frames. Video encoder 22 and video decoder 28 may operate on video blocks within individual video frames in order to encode and decode the video data. The video blocks may have fixed or varying sizes, and may differ in size according to a specified coding standard. Each video frame may include a series of slices or other independently decodable units. Each slice may include a series of macroblocks, which may be arranged into sub-blocks. As an example, the ITU-T H.264 standard supports intra prediction in various block sizes, such as 16 by 16, 8 by 8, or 4 by 4 for luma components, and 8 by 8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. Video blocks may comprise blocks of pixel data, or blocks of transformation coefficients, e.g., following a transformation process such as discrete cosine transform or a conceptually similar transformation process.

Macroblocks or other video blocks may be grouped into decodable units such as slices, frames or other independent units. Each slice may be an independently decodable unit of a video frame. Alternatively, frames themselves may be decodable units, or other portions of a frame may be defined as decodable units. In this disclosure, the term “coded unit” refers to any independently decodable unit of a video frame such as an entire frame, a slice of a frame, a group of pictures (GOPs), or another independently decodable unit defined according to the coding techniques used.

Video encoder 22 and/or video decoder 28 of system 10 of FIG. 1 may be configured to employ techniques for compression noise reduction as described in this disclosure. In particular, video encoder 22 and/or video decoder 28 may include a noise reducer that applies at least some of such techniques to reduce random noise which may be included in the video.

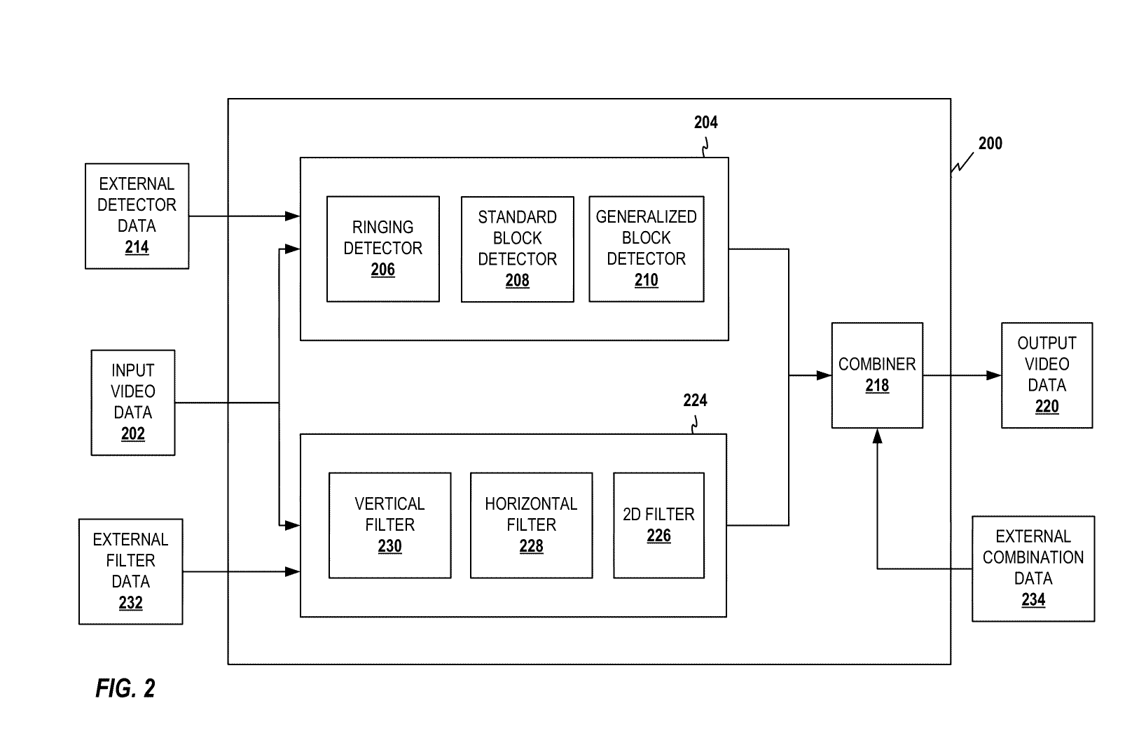

FIG. 2 is a block diagram illustrating an example of a functional block diagram of a compression noise reducer. The compression noise reducer 200 may be included in the source device 12. For example, in some implementations, it may be desirable to reduce compression noise prior to transmission. In such implementations, the compression noise reducer 200 may obtain the compressed video from the video encoder 22 and provide a noise reduced video stream for transmission. In some implementations, the compression noise reducer 200 may be included in the video encoder 22.

In some implementations, the compression noise reducer 200 may be included in the destination device 16. For example, in some implementations, it may be desirable to reduce compression noise after transmission. In such implementations, the compression noise reducer 200 may be included in the video decoder 28. In some implementations, the compression noise reducer 200 may be included as a post-decoding module. In such implementations, the compression noise reducer 200 may be configured to receive the decoded video from the video decoder 28 and reduce compression noise included in the decoded video prior to display.

The compression noise reducer 200 receives input video data 202. The input video data 202 may be a frame of video data. For ease of discussion, the input video data 202 will include a frame of video data. However, it will be understood that the systems and methods described may be adapted for input video data 202 such as macroframes, superframes, groups of pictures, or other portions of the video data. As discussed above, the input video data 202 may be an image included in a stream of video data. The input may be the actual video data or a value indicating the location of the video data. If input video data 202 is location information, the random noise reducer 200 may include a circuit configured to retrieve the pixel information for the identified input video data 202.

The input video data 202 may include luminance data for the pixels included therein. The input video data 202 may include chrominance data for the pixels included therein. In some implementations, the input video data 202 may be represented using 8 bits. In some implementations, the input video data 202 may be represented using 10 bits.

The input video data 202 may be provided to a detection module 204. The detection module 204 may include a ringing noise detector 206, a standard block detector 208, and a generalized block detector 210. The detection module 204 may also receive external detector data 214. The external detector data 214 may be obtained, for example, from a memory (e.g., configuration setting). The configuration data may include values indicating which detectors included in the detection module 204 are enabled and/or values used by one or more of the detectors. For example, a user may prefer aggressive ringing noise detection while having a higher tolerance for block detection. In such a system, the user may specify thresholds to be used for each detector to express these preferences. The external detector data 214 may be obtained from a clock, calendar, network, component of the device including the compression noise reducer, and the like.

Each detector is configured to provide a detection value 216a, 216b, and 216c (collectively referred to hereinafter as detection values 216) to a combiner 218. The combiner 218 is configured to generate output image data 220 based in part on the detection values 216.

The combiner 218 is also configured to obtain filter values 222a, 222b, and 222c (collectively referred to hereinafter as filter values 222) from filters included a filtering module 224. As shown in FIG. 2, three filters are included, a two-dimensional filter 226, a horizontal filter 228, and a vertical filter 230. Each filter obtains the input video data 202 and generates a filtered version of the input video data 202. Similar to the external detector data 214, the filtering module 224 may be configured to obtain external filter data 232. For example, the external filter data 232 may include one or more of a filter preference, a filter threshold, a filter enable/disable value, and the like.

The combiner 218 is further configured to generate the output image data 220 based in part on the filter values 222. In some implementations, the combiner 218 may also obtain the external detector data 214 and/or the external filter data 232. The combiner 218 may also receive external combination data 234. The external combination data 234 may be obtained, for example, from memory. The external combination data 234 may include values which may be used to generate the output image data 220. For example, the external combination data 234 may include user preference data indicating how one or more filtered values should contribute to the output video data 220. Table 1 below illustrates an example of external combination data 234 which may be provided to the combiner 218.

TABLE 1

| Horizontal Block | Vertical Block | Ringing | |
|---|---|---|---|
| Detected? | Detected? | Detected? | Candidate Filtering |
| No | No | Yes | Ringing |
| No | Yes | No | Horizontal block |
| No | Yes | Yes | Horizontal block |
| | | | and ringing |
| Yes | No | No | Vertical block |
| Yes | No | Yes | Vertical block and |
| | | | ringing |
| Yes | Yes | No | Horizontal block |
| | | | and vertical block |
| Yes | Yes | Yes | Horizontal block, |
| | | | vertical block, and |
| | | | ringing |

In an implementation according to Table 1, if multiple filtered values are considered, the combiner 218 may be configured to select the filtered values which represent the greatest deviation from the input value. For example, if horizontal and vertical block filterings are selected, the combiner 218 may calculate the deviation on the input pixel from the horizontal and vertical filtered output and choose the output that has the larger deviation from the input pixel value. In some implementations, the deviation may be calculated for the entire input video data (e.g., aggregate deviation for all pixels included in the input video data). In some implementations, the combiner 218 may further include a weighting factor as external combination data when selecting the filter to apply. In some implementations, the combiner 218 may be configured to combine two or more filter output values to generate the output video data.

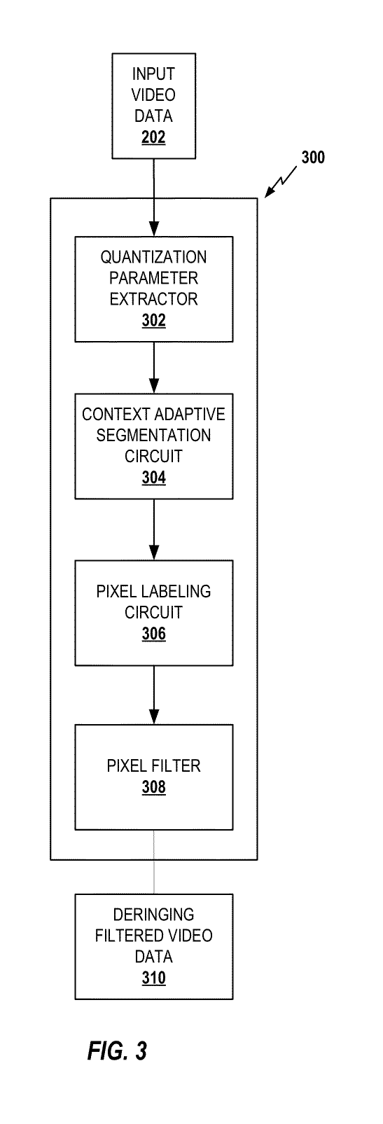

FIG. 3 illustrates a functional block diagram of a deringing filter. A deringing filter is an example of a two-dimensional filter 226. Ringing may occur close to high contrast edges in a scene. The ringing artifacts may be visible in flat areas of the scene adjacent to such edges. One approach to reducing the visibility of ringing artifacts is to detect pixels in flat areas that have small variations and apply a low pass filter to such pixels.

The deringing filter 300 shown in FIG. 3 provides per pixel adaptive interfame processing. Accordingly, in some implementations, temporal processing (e.g., buffering) may be avoided. In some implementations, temporal information may be used to facilitate the filtering, but this information is not required. The deringing filter 300 shown in FIG. 3 has an additional non-limiting advantage in that the filter does not require the block size dimension to be known before processing the input data. The deringing filter 300 shown determines the quantization parameter used for the block in which the pixel to be filtered is located. Furthermore, because the filtering may occur across block boundaries, the deringing filtered image values may also provide some deblocking.

The deringing filter 300 may be used to dering chrominance channels (e.g., Cb, Cr) and/or luminance (e.g., Y) channels. Which channels are to be filtered may be determined based on external filter data, as described above. In some implementations, the channels to be filtered may be determined dynamically such as based on data included in the input video data 202.

The deringing filter 300 obtains the input video data 202. The deringing filter 300 includes a quantization parameter extractor 302. The quantization parameter extractor 302 is configured to determine the quantization parameter used to encode the input video data.

The deringing filter 300 includes a context adaptive segmentation circuit 304. The context adaptive segmentation circuit 304 is configured to determine if a neighborhood around a pixel of interest (p(x0,y0)) is a smooth region without dominant edges or if there is a strong edge in the neighborhood. The neighborhood around the pixel of interest may be referred to as a segmentation window.

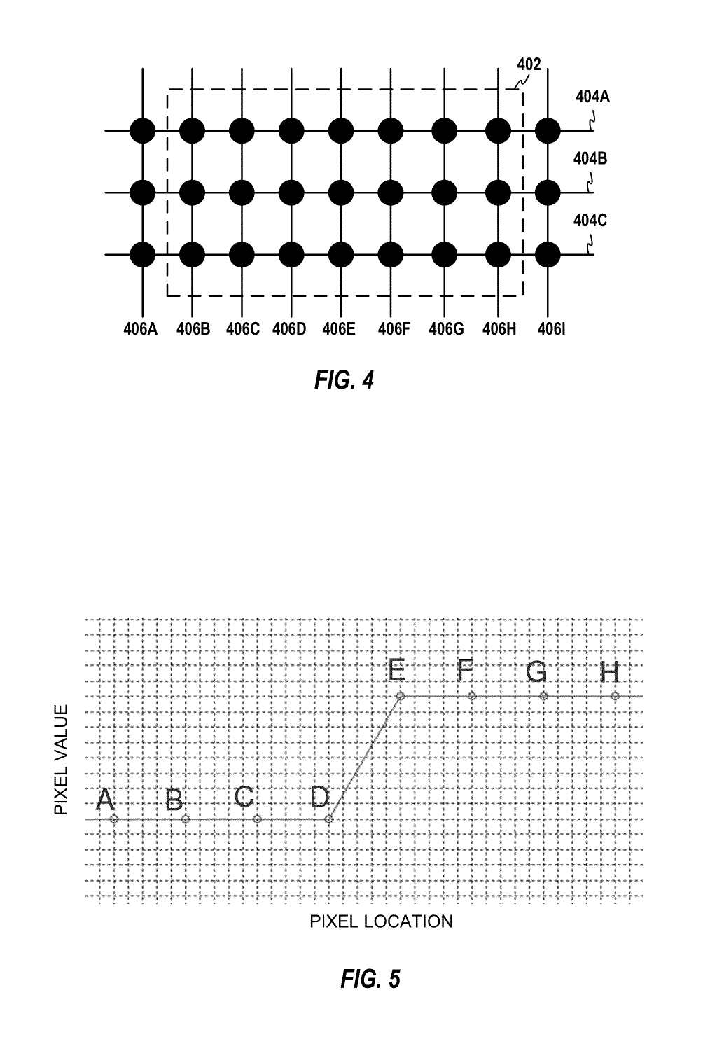

FIG. 4 illustrates a pixel diagram of an exemplary segmentation window. As shown, the segmentation window 402 includes seven columns (e.g., 406B-406H) of pixels over three rows (e.g., 404A-404C). Other segmentation window sizes (e.g., 3×7, 5×2, 11×4) may be used without departing from the scope of the present disclosure. The segmentation window size may be a pre-determined configuration selected based on the implementation of the compression noise reducer 200 and/or deringing filter 300 included therein. The segmentation window size may be dynamically determined based on, for example, the input video data 202, the video stream, the device in which the compression noise reducer 200 is included, and the like. As shown in FIG. 4, the pixel of interest is the pixel located at row 404B and column 406E. It should be noted that the segmentation window 402 does not include the pixels located in columns 406A or 406I. In the implementations shown, the pixels outside the segmentation window 402 may be considered too remote so as to factor into the filtering of the pixel of interest, that is the pixel located at row 404B and column 406E.

Returning to FIG. 3, the context adaptive segmentation circuit 304 may be configured to identify the maximum pixel value and minimum pixel value in the segmentation window for the pixel of interest. The context adaptive segmentation circuit 304 may then use these maximum and minimum values to determine whether the deringing process should be applied for this pixel of interest. Equation (1) illustrates an expression of this determination for a pixel of interest p(x0,y0) within a segmentation window of size k×l.

If range>t1*QP,dering_flag=1, else dering_flag=0 (1)

where
range=maxval−minval,
maxval=max p(i,j)∀iε[x0−k,x0+k],jε[y0−l,y0+l],
minval=min p(i,j)∀iε[x0−k,x0+k],jε[y0−l,y0+l],
t1 is a threshold value, and
QP is the quantization parameter for the block including the pixel of interest.

The dering_flag value and the image data may be provided to a pixel labeling circuit 306. The pixel labeling circuit 306 may be implemented as a low pass filter. The low pass filter may be applied to the pixel of interest if the dering_flag value is set to 1 to label pixels for filtering.

In some implementations, the threshold (t1) may be user specified. In some implementations, the filter threshold may be determined based on a specified gain and standard deviation of noise. The threshold may generally be a value greater than or equal to zero. If zero, content adaptive segmentation is essentially disabled. However, this setting will apply the filter through the image including regions without any strong edges. In some implementations, this may lead to a loss of image details. Setting the threshold to a value greater than one generally applies filtering to strong edges. As such, the likelihood that deringing filtering will occur is low in such configurations.

A basic low pass filter may be included in the pixel labeling circuit 306. In some implementations, however, it may be desirable to include a local gradient adaptive low pass filtering kernel for pixels identified for deringing. One example of a local gradient adaptive low pass filtering kernel includes determining if the gray-level value of each pixel in the m×n neighborhood around the pixel of interest is within an epsilon distance of the gray-level value of the pixel of interest. An expression of the epsilon neighborhood for a pixel of interest p(x0,y0) about a neighborhood m×n is shown in Equation (2).

$$δ ( k , l ) = \begin{matrix}1 & if \vert p ( x 0 , y 0 ) - p ( k , l ) \vert < ɛ \\ 0 & otherwise\end{matrix} \\ where \\ k ∈ [ x 0 - m , x 0 + m ] , \\ l ∈ [ y 0 - n , y 0 + n ] , \\ ɛ = t 2 * Q P , \qquad ( 2 )$$

t2 is a filter threshold value, and
QP is the quantization parameter for the block including the pixel of interest.

The labeling detects small undulations around the pixel of interest. The labeling may also exclude strong edges from the filtering process. Furthermore, the labeling prevents edge pixels from bring filtered since pixels within the m×n neighborhood around an identified edge pixel will not be within the epsilon neighborhood for the identified pixel of interest.

The filter threshold (t2) is a value indicating the magnitude of difference between the pixel of interest and a pixel in the pixel kernel which will cause the value of the pixel in the kernel to be included in the filtered pixel value. In some implementations, the filter threshold may be user specified. In some implementations, the filter threshold may be determined based on a specified gain and standard deviation of noise. The filter threshold may be set to a value greater than or equal to zero. Setting the filter threshold to zero essentially disables the filtering. If the filter threshold is set to a value greater than one, strong deringing filtering occurs since many pixels within the m×n neighborhood will be included in the filtering process. This may cause smoothing and/or edge smearing. Accordingly, the filter threshold may be adaptively determined to provide weak to strong deringing filter modes.

Having first segmented the pixels and then labeled the pixels which are to be filtered, the deringing filter 300 may further include a pixel filter 308 to generate a deringed pixel value (p′(x0,y0)) for a pixel of interest. Equation (3) is an example of a low pass filtering that may be implemented by the pixel filter 308. Equation (3) may used to filter the pixel of interest p(x0,y0) to generate a new, filtered pixel value p′(x0,y0). The pixel value filtered may be luminance value and/or chrominance value for the pixel of interest. The deringing filter 300 provides this output as a deringing filtered video data 310.

$${p}^{′} ( x 0 , y 0 ) = \frac{λ p ( x 0 , y 0 ) + {\sum }_{k = x 0}^{x 0 + m} {\sum }_{l = y 0 - n}^{y 0 + n} p ( k , l ) \times δ ( k , l )}{λ + γ} \\ where \\ γ = {\sum }_{k = x 0 - m}^{x 0 + m} {\sum }_{l = y 0 - n}^{y 0 + n} δ ( k , l ) \\ k ∈ [ x 0 - m , x 0 + m ] \\ l ∈ [ y 0 - n , y 0 + m ] \qquad ( 3 )$$

and where
m is the width of the pixel kernel,
n is the height of the pixel kernel,
δ(k,l) is the pixel label from Equation (2), and
λ is a blending factor.

As discussed above, the height and width of the pixel kernel may be pre-determined or adaptively determined. The blending factor is a value that determines a magnitude for the potential filtered pixel value. The blending factor may be pre-determined (e.g., stored in memory) or adaptively determined based on one or more of the video, the type of video (e.g., sports, movie), the target display, or the like. In some implementations, the blending factor may be a value between 8 and 16. In some implementations, the blending factor may be 3, 26, or 40. The filter kernel m×n may be selected such that it is large enough to span ringing artifacts but not so large as to cause blurring of the image. In some implementations, the filter kernel size may be the same as the segmentation window size. The choice of segmentation window and filter kernel size involves a trade-off between implementation complexity and ringing artifact reduction capability. 5×1 and 9×1 are two example configurations for segmentation window or filter kernel sizes which provide balanced implementations.

FIG. 5 is a plot of pixel values illustrating a blocking artifact. The plot shown in FIG. 5 includes pixel values on the y-axis and pixel locations on the x-axis. The pixels are labeled A through H. Pixels A through D have the same pixel value. Pixels E through H have the same pixel value, though different from the pixel values for pixels A through D. The blocking artifact may be identified between pixels D and E based on the difference in pixel values between pixels D and E.

The plot in FIG. 5 may be used to show the pixel values along a horizontal line or a vertical line. As such, a vertical blocking detector or a horizontal blocking detector may be used to identify blocking artifacts.

Returning to FIG. 2, the standard block detector 208 it is assumed that an 8×8 block was used to compress the input video data. Accordingly, pixel values for eight contiguous pixels may be compared to identify blocking artifacts. One example comparison includes generating five index values indicating different levels of flatness for a series of pixel values. Table 2 below shows five example index values which may be generated by the standard block detector 208.

TABLE 2

| Flatness Index Number | Value |
|---|---|
| 1 | abs(A-B) + abs(B-C) + abs(C-D) < ft1 |
| 2 | abs(E-F) + abs(F-G) + abs(G-H) < ft2 |
| 3 | abs(max(A,B,C,D)-min(A,B,C,D)) < ft3 |
| 4 | abs(max(E,F,G,H)-min(E,F,G,H)) < ft4 |
| 5 | abs(mean(A,B,C,D)-mean(E,F,G,H)) > ft5 |

In Table 2, t1, ft2, ft3, ft4, and ft5 are flatness threshold values. The flatness threshold values may be user specified. In some implementations, the flatness threshold values may be determined dynamically such as based on data included in the input video data.

The standard block detector 208 may be configured to generate a detection value based on the index values. For example, the standard block detector 208 may identify the block if all five values are true. In some implementations, the identification may be positive if three of the five values are true.

The standard block detector 208 may detect horizontal and vertical blocks. As such, two parallel detectors may be included for detecting horizontal and vertical blocks. In some implementations, the standard block detector 208 may be configured to perform both horizontal and vertical blocks using the same unit. The number of pixel values to consider may be the same when detecting vertical and horizontal blocks. In some implementations, the number of pixel values to compare may be different for vertical and horizontal blocks. For example, the horizontal block may be detected using eight pixel values while vertical block detection may be performed using four pixel values.

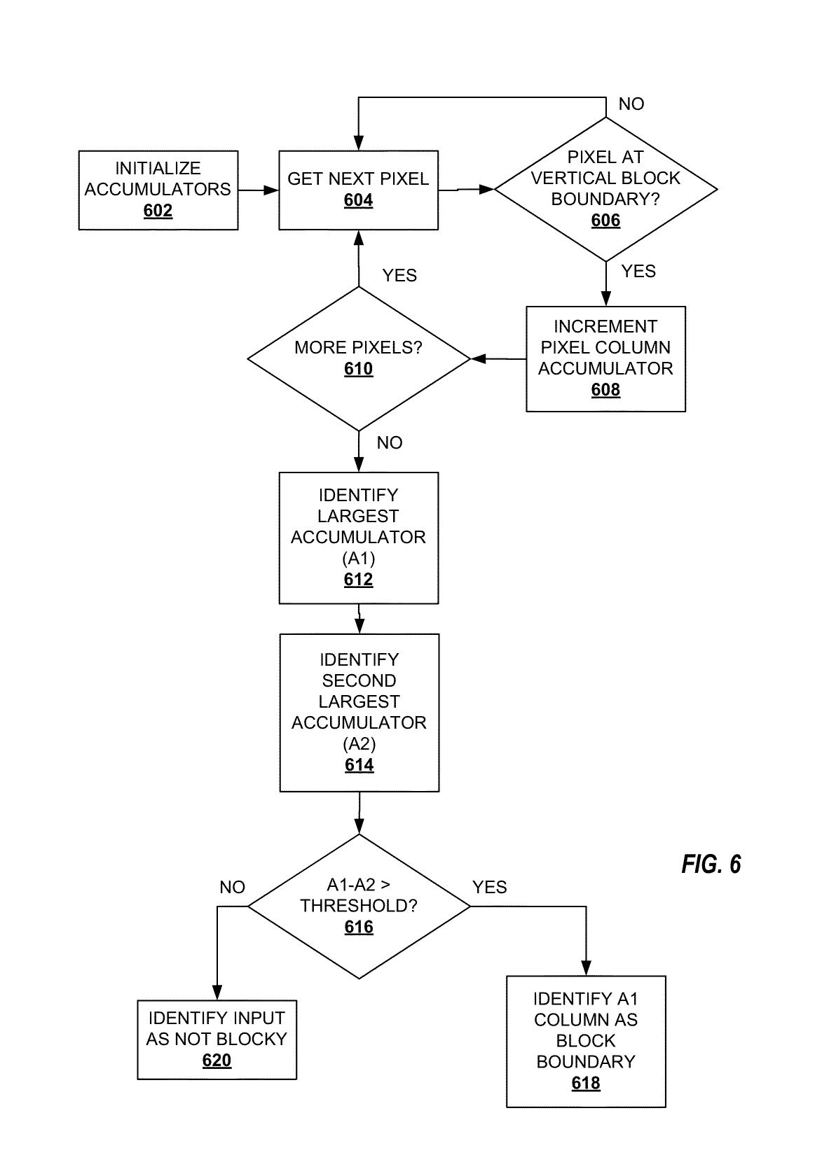

FIG. 6 is a process flow diagram illustrating vertical block grid detection. The process shown in FIG. 6 may be implemented in the standard block detector 208. The process receives two values as inputs: the input video data and a detection threshold. The process is configured to identify vertical block grids in the input video data by analyzing at least some of the pixels included in the input video data. The analysis may proceed horizontally across rows pixels or vertically along columns of pixels. The input video data may be provided in smaller portions such as frames. However, whether provided in whole or in part, the process shown in FIG. 6 may be used to detect vertical block grid in the input video data.

The process shown in FIG. 6 may be used to determine if a vertical block grid exists for the input video data. If it is determined that a grid exists at a portion or for the entire input video data, the input video data includes a visible grid pattern which may be removed using deblocking. As this is a standard detection scheme, the assumption is that if a grid exists, it will exhibit itself within a standard block size such as an 8×8 block. Accordingly, in vertical grid detection, the process seeks to find the column which represents the block grid boundary.

At node 602, a number of accumulators are initialized to zero. The number of accumulators is determined based on the standard block size expected. For example, if an 8×8 block size is the standard block size, eight accumulators will be initialized each corresponding to a column of pixels in the block.

At node 604, the next pixel of video data is obtained. At node 606, a determination is made as to whether the pixel lies near a vertical block boundary. This determination may be performed as described above. If the pixel is determined not to be near a vertical block boundary, the process returns to node 604 to obtain the next pixel of video data. If the pixel is determined to be near a vertical block boundary, at node 608, the accumulator associated with the column of the pixel is incremented. For the first block, the column number may be the same as the accumulator. However, for subsequent blocks, the column number will be larger than eight. In such cases, the accumulator to be incremented may be identified by taking the column number for the pixel modulo 8. At node 610, a determination is made as to whether there are more pixel values to process. If so, the process returns to node 604 as described above.

If all pixels have been processed, at node 612, the largest accumulator is identified. The largest accumulator is identified as having the highest count value. At node 614, the second largest accumulator is identified. The second largest accumulator is identified as the accumulator having the second highest count value.

At decision node 616, the identified first and second accumulator count values are compared to the provided detection threshold. As shown in FIG. 6, the determination compares the difference between the first and second accumulator counts to the threshold. If the difference is larger than the detection threshold, then at node 618, the column associated with the largest accumulator is identified as the vertical block grid boundary. Otherwise, at node 620, the input video data is identified as not being blocky.

The process shown in FIG. 6 describes the process for vertical block grid detection. However, a similar process may be used to detect the presence of a horizontal block grid. In such implementations, the accumulators would correspond to rows rather than columns for pixels identified along a horizontal block boundary rather than a vertical block boundary.

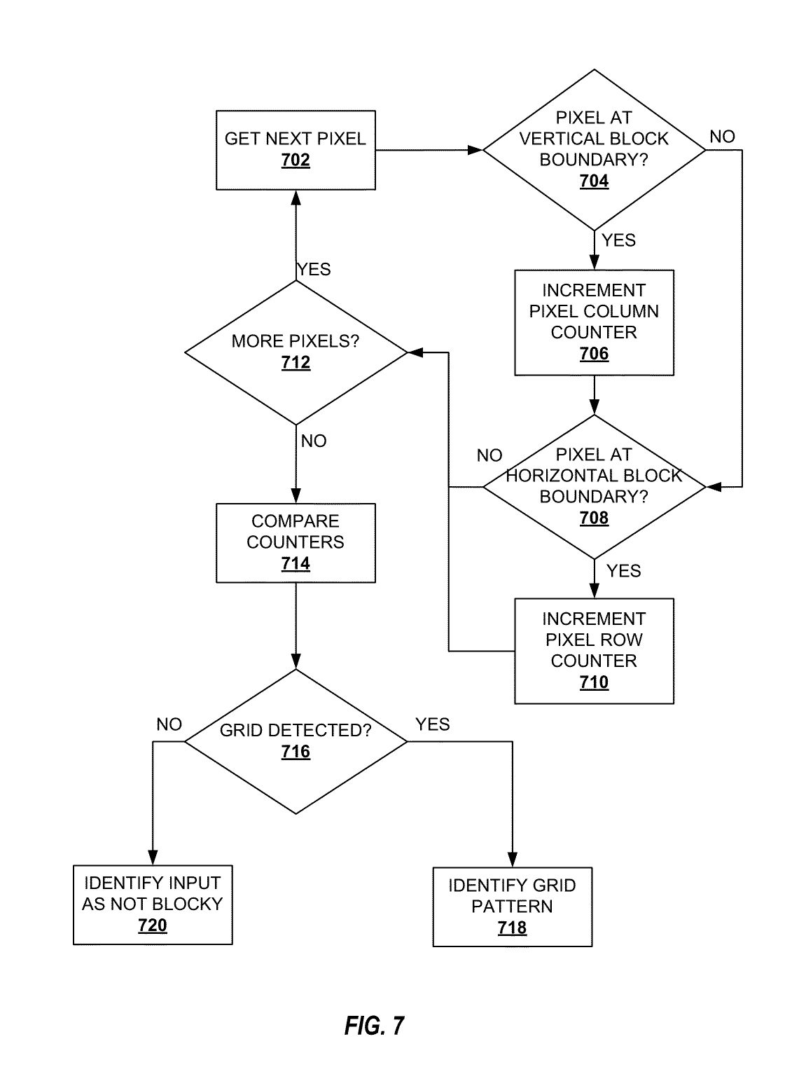

FIG. 7 shows a process flow diagram for generalized block grid detection. Although standard block sizes may be generally assumed, the standard sizing may not be applicable to all input video data. For example, content may be scaled before noise reduction. Therefore, it may be desirable in some implementations to detect the presence of a block grid of any size. In some cases, due to scaling, the size may also include fractional sizes. The generalized block grid detection may be implemented by the generalized block detector 210.

At node 702, a pixel of input video data is obtained. At decision node 704, a determination is made as to whether the pixel lies along a vertical block boundary. If so, at node 706, a counter associated with the column in which the pixel is located is incremented. The process continues to node 708 as will be described below.

The block boundary detection may be performed similar to the block boundary detection describe above. In some implementations, for generalized block boundary detection, it may be advantageous to compare two sets of pixels which are separated by one or more pixels. For example, as shown in FIG. 5, a contiguous line of eight pixels are compared using the standard boundary detection method.

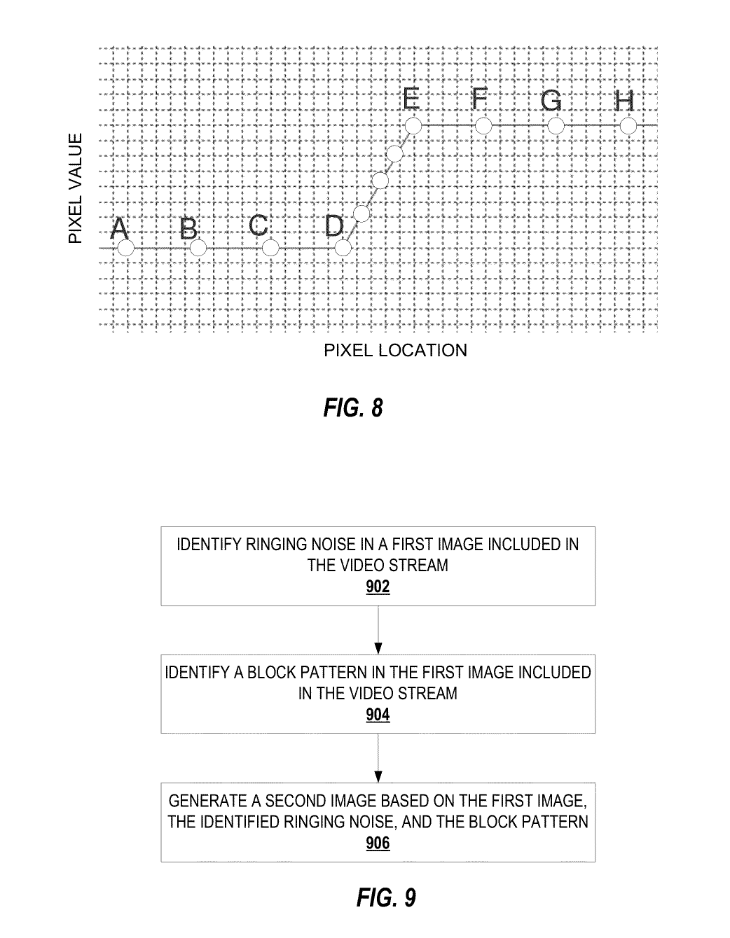

FIG. 8 illustrates another plot of pixel values illustrating a blocking artifact. The plot shown in FIG. 8 includes pixel values on the y-axis and pixel locations on the x-axis. The pixels are labeled A through H. Pixels A through D have the same pixel value. Pixels E through H have the same pixel value, though different from the pixel values for pixels A through D. The blocking artifact may be identified between pixels D and E based on the difference in pixel values between pixels D and E. However, unlike in FIG. 5, there are some pixels between pixels D and E which are not analyzed as part of the generalized block boundary detection. This selection of pixels may provide effective detection of block boundaries given that the input video data may have been pre-scaled and therefore the block boundaries may not be as sharp as in the un-scaled version. The detection may proceed similarly to the standard block detection described above (e.g., using the analytics included in Table 2).

Returning to decision node 704, if the pixel does not lay along a vertical block boundary, at node 708, a determination is made as to whether the pixel lies along a horizontal block boundary. The horizontal block boundary detection may include the separation discussed above with reference to node 704. If so, at node 710, a counter associated with the row in which the pixel is located is incremented. The process continues to node 712 as will be described below.

Returning to decision node 708, if it is determined that the pixel does not lie along a horizontal block boundary, the process continues to decision node 712. At decision node 712, a determination is made as to whether more pixels are available for processing. If so, the process returns to node 702. If not, the process continues to node 714 where the counters associated with each column and each row are compared. The comparison may analyze the counters which provide two one-dimensional grid profiles for the video data. The analysis may include a frequency transform (e.g., DFT, DCT, Hadamard, etc.) to identify a periodic block signature for the video data. For example, if the DCT coefficient cᵢ is high (e.g., greater than a threshold value), it may correspond to a periodic pattern of period 2N/i where N is the length of the transform. In conducting the analysis, certain assumptions may be included to expedite the processing of the accumulator counts. For example, since the block size may be assumed to lie between a range of block size values such as between eight and thirty-two, not all coefficients need be computed. The range of values may be provided as external detection data, based on the input video data, or the like. For example, if N is 1024, computing 210 coefficients is sufficient to detect block sizes in the range of eight to thirty-two.

In some implementations, the generalized block detector 210 may be configured to perform the coefficient computation during blank time between portions of the input video data. For example, if block detection is performed one in two frames, then the coefficients may be determined during an entire frame time (e.g., the grid profile is created every odd frame and coefficients are generated every even frame). Given this generous time allocation, the coefficients may be calculated without including additional hardware to expedite the processing. For example, one MAC unit and LUTs for the trigonometric twiddle factors may be included in the generalized block detector 210 to implement the described process.

At decision node 716, a determination is made as to whether a block grid has been detected based on the comparison. If a grid is detected, at node 718, the generalized block detector 210 may provide a value indicating the detection to the combiner 218. The detection may take the form of a grid pattern with a period of N pixels. In such cases, the row and column accumulators would have high count values in bins that align to the block grid and low values elsewhere. The combiner 218 may use this information or provide this information to one or more filters to globally filter the video data. If a grid is not detected, at node 720, this information is provided by the generalized block detector 210.

The counters may be thresholded. For example, if the counter for a given row is greater than a generalized horizontal block threshold value, the row is flagged using a one bit value indicating a grid at the associated row. This may reduce the amount of information which is provided to the combiner 218 for subsequent filter processing. The length of each accumulator may also be limited (e.g., saturated). For example, the accumulator may be limited to a power of 2 (e.g., 512 or 1024). This may be useful in implementations where subsequent frequency transforms are performed on the accumulator values to, for example, reduce the processing requirements for the count values.

Returning to FIG. 2, the standard block detector 208 and/or the generalized block detector 210 may provide block boundary information for each pixel as well as any grid patterned detected to the combiner 218. This information may be used by the combiner 218 to apply the filtering rules as shown and described in Table 1 above. For example, when block grids are detected, filtering may be applied along the vertical or horizontal axes for subsequent portions of video data. Furthermore, the combiner 218 may be configured to filter all pixels that lie on the block grid. In some implementations, the combiner 218 may be configured to apply filtering only to those pixels that lie on the block grid and are marked as block boundaries. In some implementations, the combiner 218 may provide this information to the horizontal filter 228 and/or vertical filter 230 to perform the filtering accordingly. To perform this forward looking filtering, a temporal history of the block grid detection values may be maintained such as in a memory. The deblocker may be configured to change state from filtering to no filtering (or vice versa) after a configurable number of frames. The duration may be based on external filter data, external combination data, the input video stream, user preferences, and the like.

The horizontal filter 228 may include dynamic filter coefficients. The filter coefficients may be determined based on the compression profile of the input video data 202. The compression profile includes the quantization parameter for the input video data, bit rate of the input video data 202, and the ringing and block detection values. For example, low bit rate video generally has a lower quality. According, stronger filtering coefficients may be selected where the bit rate is low. In some implementations, the horizontal filter 228 may include eight taps for filtering standard definition as well as high definition video data.

The vertical filter 230 may also include dynamic filter coefficients. As with the horizontal filter 228, the filtering coefficients may be selected based on the compression profile for the input video data 202. For example, as described above, stronger filtering coefficients may be selected where there bit rate is low. It may be desirable to include defined filtering parameters for video which is below a specified bit rate. For example, Equation 4 shows one expression of a filter that may be implemented in a filter included in the compression noise reducer 200.

$$y ( n ) = {\sum }_{n = 1}^{N} x ( i - n ) * h ( i ) \\ where \\ H = [ \begin{matrix}0.0908 & 0.1054 & 0.1167 \\ 0.1239 & 0.1263 & 0.1239 \\ 0.1167 & 0.1054 & 0.0908\end{matrix} ] and \qquad ( 4 )$$

N is the block size.

In cases where the bit rate is higher than the specified minimum, a nearest fixed point approximation may be used to generate the filtered pixel value. In some implementations, the vertical filter 230 may include eight taps for filtering standard definition video data and four taps for filtering high definition video data.

Information provided by the standard block detector 208 and/or the generalized block detector 210 may be used to determine whether deblocking is needed for the entire input video data 202 (e.g., global deblocking) or portions of the input video data 202 (e.g., local deblocking). For example, the total number of vertical and horizontal block boundaries may be provided to the combiner. If the total deblock boundary counter is greater than a threshold number of deblock boundaries, the image may be deemed of such low quality as to warrant global deblock filtering. The threshold may be provided as external filter data 232 and/or external combination data 234. The threshold may be determined based on a maximum number of deblocking boundaries for the input video data 202. Equation 5 shows an example expression for determining whether to apply global filtering.

boundary_count>threshold*max(Deblock_boundaries) (5)

If global filtering is determined to be appropriate, the deblocking mask may be set to 1 for all pixels in the input video data 202 thus indicating that deblocking may be used for the input video data 202. To prevent fast switching between global and local filtering, hysteresis may be included.

FIG. 9 illustrates a process flow diagram for a method of reducing noise of a video stream. The process shown in FIG. 9 may be implemented in whole or in part by one or more of the devices described herein, such as that shown in FIG. 2. At block 902 ringing noise is identified in a first image included in the video stream. At block 904, a block pattern is identified in the image included in the video stream, wherein identifying the block pattern includes identifying block patterns of a predetermined size and block patterns of an arbitrary size. At block 906, a second image is generated based on the first image, the identified ringing noise, and the block pattern.

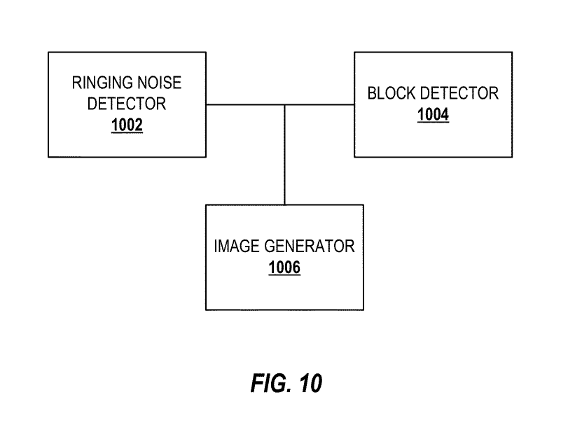

FIG. 10 illustrates a functional block diagram for another exemplary noise reducer. Those skilled in the art will appreciate that a noise reducer may have more components than the simplified noise reducer 1000 illustrated in FIG. 10. The noise reducer 1000 shown in FIG. 10 includes only those components useful for describing some prominent features of implementations with the scope of the claims. The noise reducer 1000 includes a ringing noise detector 1002, a block detector 1004, and a pixel generator 1006.

The ringing noise detector 1002 is configured to identify ringing noise in a first image included in the video stream. The ringing noise detector 1002 may include one or more of a processor, a pixel extractor, a comparator, a look up table, a memory, and an arithmetic unit. In some implementations the means for identifying ringing noise may include the ringing noise detector 1002.

The block detector 1004 is configured to identify block pattern in the image included in the video stream, wherein identifying the block pattern includes identifying block patterns of a predetermined size and block patterns of an arbitrary size. The block detector 1004 may include one or more of a processor, a memory, a standard block detector, a generalized block detector, an arithmetic unit, and a buffer. In some implementations, the means for identifying a block pattern in the image included in the video stream includes the block detector 1004.

The image generator 1006 is configured to generate a second image based on the first image, the identified ringing noise, and the block pattern. The image generator 1006 may include one or more of a processor, a look up table, an external data source, a memory, a comparator, and an image filter. In some implementations, the means for generating a second image include the pixel generator 1006.

As used herein, the terms “determine” or “determining” encompass a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an encoding device and/or decoding device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A device for noise reduction of a video stream, the device comprising:
a ringing noise detector configured to identify ringing noise in an image included in the video stream;
a block detector configured to identify a block pattern in the image included in the video stream, the block detector configured to identify block patterns of a predetermined size and block patterns of an arbitrary size; and
a noise reducer configured to filter the image based on the identified ringing noise and the block pattern.

2. The device of claim 1, wherein identifying ringing noise is based at least in part on the identified block pattern.

3. The device of claim 1, further comprising a memory configured to store the identified block pattern of the image, the noise reducer configured to filter the image based on the stored block pattern.

4. The device of claim 1, wherein filtering the image includes at least one of horizontal filtering and vertical filtering.

5. The device of claim 1, wherein filtering the image includes at least one of deblocking and deringing the image.

6. The device of claim 5, wherein deblocking includes deblocking the entire image when the block pattern is identified and deblocking a portion of the image otherwise.

7. The device of claim 5, wherein deblocking includes deblocking the entire image based on a comparison of the block characteristics of the image to a threshold value.

8. The device of claim 5, wherein deringing is based in part on an identified block pattern.

9. The device of claim 5, wherein deringing comprises:
identifying a quantization parameter associated with the input video data;
determining whether a first pixel lies near an area of contrast included in the first image based on a comparison of a first pixel value for the first pixel with a plurality of pixels located near the pixel; and
generating a second pixel value based on the first pixel value and a determination that the first pixel lies near an area of contrast.

10. The device of claim 9, wherein the plurality of pixels are located in a continuous region of the first image.

11. The device of claim 9, wherein the plurality of pixels comprises:
a first set of contiguous pixels; and
a second set of contiguous pixels, wherein at least one pixel is located between the first set and second set of pixels, the at least one pixel not included in either the first set or second set of pixels.

12. The device of claim 1, wherein the video data includes scaled video data.

13. The device of claim 1, wherein the video data includes a first portion encoded using a first codec and a second portion encoded using a second codec.

14. A method for noise reduction of a video stream, the method comprising:
identifying ringing noise in a first image included in the video stream;
identifying a block pattern in the image included in the video stream, wherein identifying the block pattern includes identifying block patterns of a predetermined size and block patterns of an arbitrary size; and
generating a second image based on the first image, the identified ringing noise, and the block pattern.

15. The method of claim 14, wherein identifying ringing noise is based at least in part on the identified block pattern.

16. The method of claim 14, further comprising storing the identified block pattern of the image, wherein filtering the image based on the stored block pattern.

17. The method of claim 14, wherein filtering the image includes at least one of horizontal filtering and vertical filtering.

18. The method of claim 14, wherein filtering the image includes at least one of deblocking and deringing the image.

19. The method of claim 18, wherein deblocking includes deblocking the entire image when the block pattern is identified and deblocking a portion of the image otherwise.

20. The method of claim 18, wherein deblocking includes deblocking the entire image based on a comparison of the block characteristics of the image to a threshold value.

21. The method of claim 18, wherein deringing is based in part on an identified block pattern.

22. The method of claim 18, wherein deringing comprises:
identifying a quantization parameter associated with the input video data;
determining whether a first pixel lies near an area of contrast included in the first image based on a comparison of a first pixel value for the first pixel with a plurality of pixels located near the pixel; and
generating a second pixel value based on the first pixel value and a determination that the first pixel lies near an area of contrast.

23. The method of claim 22, wherein the plurality of pixels are located in a continuous region of the first image.

24. The method of claim 22, wherein the plurality of pixels comprises:
a first set of contiguous pixels; and
a second set of contiguous pixels, wherein at least one pixel is located between the first set and second set of pixels, the at least one pixel not included in either the first set or second set of pixels.

25. The method of claim 14, wherein the video data includes scaled video data.

26. The method of claim 14, wherein the video data includes a first portion encoded using a first codec and a second portion encoded using a second codec.

27. A device for noise reduction of a video stream, the device comprising:
a processor configured to:
identify ringing noise in a first image included in the video stream;
identify a block pattern in the image included in the video stream, wherein identifying the block pattern includes identifying block patterns of a predetermined size and block patterns of an arbitrary size; and
generate a second image based on the first image, the identified ringing noise, and the block pattern.

28. A computer-readable storage medium comprising instructions executable by a processor of an apparatus for noise reduction of a video stream, the instructions causing the apparatus to:
identify ringing noise in a first image included in the video stream;
identify a block pattern in the image included in the video stream, wherein identifying the block pattern includes identifying block patterns of a predetermined size and block patterns of an arbitrary size; and
generate a second image based on the first image, the identified ringing noise, and the block pattern.

29. A device for noise reduction of a video stream, the device comprising:
means for identifying ringing noise in a first image included in the video stream;
means for identifying a block pattern in the image included in the video stream, wherein identifying the block pattern includes identifying block patterns of a predetermined size and block patterns of an arbitrary size; and
means for generating a second image based on the first image, the identified ringing noise, and the block pattern.
